(19) United States
(12) Patent Application Publication
(10) Pub. No.: US 2014/0222320 A1
(43) Pub. Date: Aug. 7, 2014

(54) OPERATING METHOD OF ROAD GUIDE SYSTEM AND ROAD GUIDE METHOD OF PORTABLE DEVICE

(71) Applicant: Electronics and Telecommunications Research Institute, Daejeon (KR)

(72) Inventors: Chun-Gi LYUH, Daejeon (KR); Ik Jae CHUN, Daejeon (KR); Jung Hee SUK, Daejeon (KR); Tae Moon ROH, Daejeon (KR)

(73) Assignee: Electronics and Telecommunications Research Institute, Daejeon (KR)

(21) Appl. No.: 14/095,702

(22) Filed: Dec. 3, 2013

(30) Foreign Application Priority Data
Feb. 5, 2013 (KR) 10-2013-0013011

(51) Int. Cl. G01C 21/34

(52) U.S. Cl. CPC G01C 21/3492
USPC 701/117

(57) ABSTRACT

Provided is an operating method of a road guide system including collecting traffic information around a portable device through the portable device; delivering, to a server, the traffic information collected from the portable device and travel path information; updating the delivered travel path information based on the delivered traffic information; and feeding back the updated travel path information from the server to the portable device.

### CROSS-REFERENCE TO RELATED APPLICATIONS

This U.S. non-provisional patent application claims priority under 35 U.S.C. §119 of Korean Patent Application No. 10-2013-0013011, filed on Feb. 5, 2013, the entire contents of which are hereby incorporated by reference.

### BACKGROUND OF THE INVENTION

The present invention disclosed herein relates to a road guide system, and more particularly, to an operating method of a road guide system that reflects a traffic condition in real time through the interaction between a portable device and a server.

A road guide system provides a road guide service from a point of departure to a destination in response to a user request. The road guide system uses a map and location recognizing equipment such as a global positioning system (GPS) in order to provide a road guide service. The road guide system provides to a user a travel path according to the shortest time and the shortest distance based on a preset destination. Also, the road guide system stores map data and various types of content. The map data is generated based on road and traffic control conditions that are previously investigated. The content may include information that represents locations of restaurants, hotels, and attractions.

Typically, existing road guide systems have a limitation in that information on a traffic condition is not provided to a user in real time. For example, when traffic congestion becomes serious due to unexpected traffic accidents, traffic information changed due to the traffic accidents is not updated for the road guide service in real time. Thus, a user continues to use the existing road guide service that the traffic congestion has not been reflected. Until now, most road guide systems have provided, to the user, only traffic information based on road congestion and regulated speed. Thus, there is a need for a road guide system that may provide, to the user, information on real-time traffic conditions, such as road conditions, unexpected traffic congestions, etc.

Recently, a real-time road guide system using transport protocol expert group (TPEG) has been developed. The road guide system using the TPEG grasps a traffic condition in real time based on the congestion section of a road. However, the road guide system using the TPEG fails to provide a road guide service in real time with respect to unexpected traffic conditions, such as road damages, traffic accidents, etc. For example, the road guide service using the TPEG provides a road guide service in which information on bypass may be provided, only after a region where the unexpected traffic accident occur becomes a congestion section. Thus, there is a need for a road guide service that may cope, in real time, with unexpected traffic conditions, not the congestion section.

### SUMMARY OF THE INVENTION

The present invention provides an operating method of a road guide system that provides a travel path service in real time based on exact traffic conditions, through the interaction between a portable device and a server.

Embodiments of the present invention provide operating methods of a road guide system, the operating method including collecting traffic information around a portable device through the portable device; delivering, to a server, the traffic information collected from the portable device and travel path information; updating the delivered travel path information based on the delivered traffic information; and feeding back the updated travel path information from the server to the portable device.

In other embodiments of the present invention, road guide methods of a portable device include searching for travel path information based on map information; determining traffic conditions according to image information obtained by an imaging device; transmitting the determined traffic situations and positional information to the server; receiving, from the server, travel path information updated according to the traffic conditions; and performing a road guide based on the updated travel path information.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram of a road guide system according to an embodiment of the present invention;

FIG. 2 is a block diagram of a portable device according to an embodiment of the present invention;

FIG. 3 is a block diagram of a server according to an embodiment of the present invention; and

FIG. 4 is a flow chart of how a road guide system according to an embodiment of the present invention operates.

### DETAILED DESCRIPTION OF PREFERRED EMBODIMENTS

In order to prescribe the present invention in detail so that a person skilled in the art may easily practice the technical spirits of the present invention, embodiments of the present invention are described below with reference to the accompanying drawings. The same components are denoted by using the same reference numerals. Like components are denoted by using similar reference numerals. A road guide system according to the present invention to be described below and operations to be performed by using the system are merely described as examples and various variations and alterations may be made within the scope of the technical spirit of the present invention.

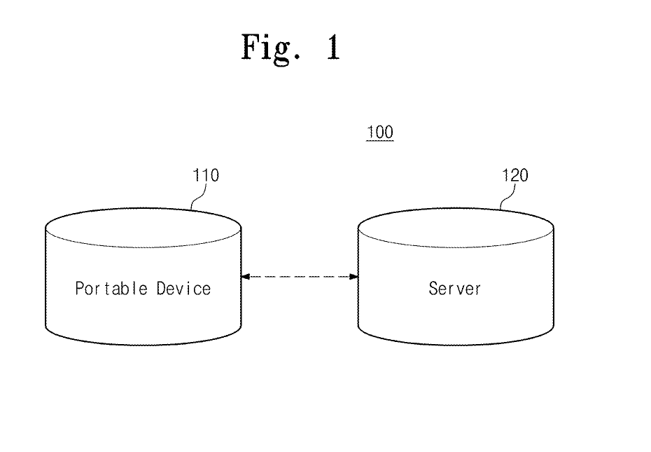

FIG. 1 is a block diagram of a road guide system according to an embodiment of the present invention. Referring to FIG. 1, a road guide system 100 includes a portable device 110 and a server 120. The road guide system 100 provides to a user a travel path service based on real-time traffic conditions, through the interaction between the portable device 110 and the server 120.

The portable device 110 provides to the user the travel path service according to a preset destination. The travel path means a travel path having the shortest distance or the shortest time from a point of departure to the destination. The portable device 110 may be implemented as a vehicle navigation device, a smart phone, a tablet PC, etc. The portable device 110 may be an electronic device that may communicate with the server 120.

The portable device 110 receives information on surrounding traffic conditions and transmits the information to the server 120. For example, the surrounding traffic conditions may include congestion due to unexpected accidents. As another example, the surrounding traffic conditions may include road damages due to natural disaster. Information on the surrounding traffic conditions are imaged through an imaging device that is installed in the portable device 110. A camera may be used as the imaging device.

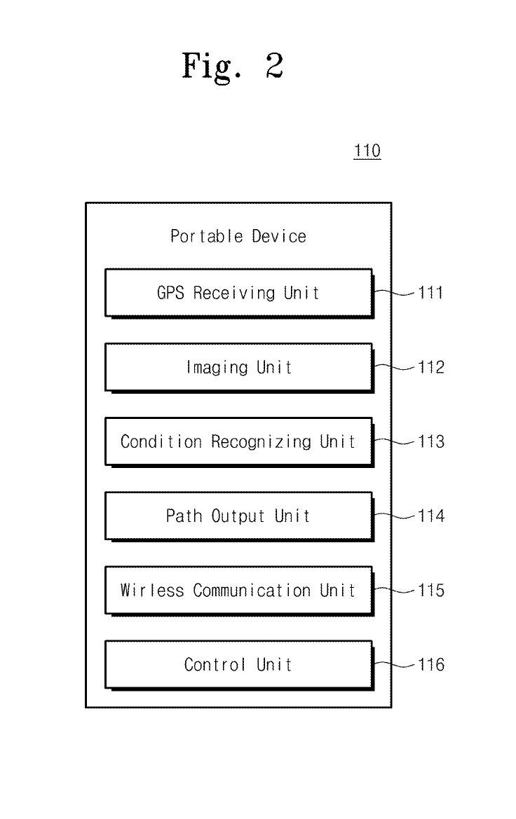

Also, the surrounding traffic conditions may be imaged by using an imaging device in a vehicle, not the imaging device in the portable device 110. For example, the imaging device in the vehicle may include a black box. When the traffic conditions are imaged by using the black box, the portable device 110 operates in conjunction with the black box. The portable device 110 images the surrounding traffic conditions in real time by using an imaging device such as a camera or a black box. Although the camera and the black box are described as equipment imaging the surrounding traffic conditions, the technical spirit of the present invention is not limited thereto. The configuration of the portable device 110 is described in detail with reference to FIG. 2.

The server 120 continues to receive information on the surrounding traffic conditions received from the portable device 110. The server 120 feeds back, to the portable device 110, information on a travel path reset based on the received information.

Also, the server 120 stores various types of traffic information and map information that are required for a road guide service. The server 120 updates the existing map and traffic information in real time based on the traffic information received from the portable device 110.

As described above, the road guide system 100 updates traffic information in real time through the interaction between the portable device 110 and the server 120. The road guide system 100 grasps unexpected traffic conditions and predicts a congestion section to provide to a user a travel path service in which information bypassing a congestion-predicted section is provided. Through the road guide system 100, the user may use an exact travel path service that is updated in real time.

FIG. 2 is a block diagram of a portable device according to an embodiment of the present invention. Referring to FIG. 2, a portable device 110 includes a GPS receiving unit 111, an imaging unit 112, a condition recognizing unit 113, a path output unit 114, a wireless communication unit 115, and a control unit 116.

The GPS receiving unit 111 receives positional information for grasping the current position of a vehicle. The GPS receiving unit 110 delivers the received positional information to the condition recognizing unit 113. For example, if natural disaster occurs, the GPS receiving unit 111 grasps where the natural disaster occurs and then the grasped positional information to the condition recognizing unit 113. The imaging unit 112 images the surrounding traffic conditions of a running vehicle. For example, the imaging unit 112 images, in real time, accidents that may unexpectedly occur, such as vehicle accidents and road damages. The imaging unit 112 delivers, to the condition recognizing unit 113, information imaged in real time.

The imaging unit 112 may be implemented as a camera-type imaging device. For example, a user may image the surrounding traffic conditions of a vehicle by using a camera that is installed in his/her smart phone or tablet PC. As another example, the surrounding traffic conditions may be imaged automatically in conjunction with an external device, not by the user's direction operation. For example, it is possible to continuously image the surrounding traffic conditions through a black box that operates in conjunction with the portable device 110.

The condition recognizing unit 113 receives positional information from the GPS receiving unit 111. Also, the condition recognizing unit 113 receives image information from the imaging unit 112. The condition recognizing unit 113 generates real-time traffic information corresponding to the position of a vehicle, based on the positional information received from the GPS receiving unit 111 and the image information received from the imaging unit 112. For example, the condition recognizing unit 113 recognizes the traffic of each lane, road conditions, and which lane has a vehicle accident, based on the position of a vehicle and traffic conditions. The condition recognizing unit 113 delivers the realized real-time traffic information to the server 120 through the wireless communication unit 115.

The path output unit 114 shows to a user a travel path from a point of departure to a destination. If a new travel path is received from the server through the wireless communication unit 115, the path output unit 114 updates the previous travel path. The path output unit 114 shows the updated travel path to the user.

The wireless communication unit 115 transmits real-time traffic information received from the condition recognizing unit 113, to the server 120. Also, the wireless communication unit 115 transmits the currently set travel path information to the server 120. The wireless communication unit 115 may transmit information to the server 120 by using one of communication techniques such as wireless LAN (WLAN), wireless broadband (Wibro), GSM, CDMA, LTE, and AT-DMB technologies. Also, the wireless communication unit 115 receives traffic information from the server 120. As described above, the wireless communication unit 115 exchanges information with the server 120 through wireless communication. The control nit 116 controls the operation of each component in the portable device 110. For example, the control unit 116 allows information received through the GPS receiving unit 111 and the imaging unit 112 to be transmitted to the condition recognizing unit 113. Also, the control unit 116 allows the wireless communication unit 115 to transmit and receive information in conjunction with the server 120.

As described above, the portable device 110 continuously delivers, to the server, information obtained by imaging the surrounding traffic conditions. The portable device 110 may provide to a user a travel path service reflecting real-time traffic conditions, through the interaction with the server 120.

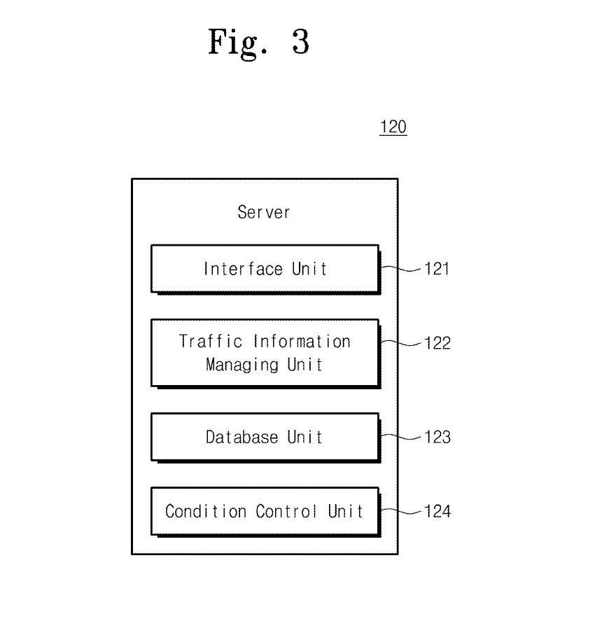

FIG. 3 is a block diagram of a server according to an embodiment of the present invention. Referring to FIGS. 2 and 3, a server 120 includes an interface unit 121, a traffic information managing unit 122, a database unit 123, and a condition control unit 124.

The interface unit 121 receives real-time traffic information and information on a travel path from the wireless communication unit 115. The interface unit 121 delivers to the traffic information managing unit 122 the information received through the wireless communication unit 115. Also, the interface unit 121 receives information on an updated travel path from the traffic information managing unit 122. Also, the interface unit 121 feeds back, to the wireless communication unit 115, information received from the traffic information managing unit 122.

The traffic information managing unit 122 receives the real-time traffic information and the information on a travel path from the interface unit 121. The traffic information managing unit 122 updates traffic information based on the received real-time traffic information. For example, the traffic information managing unit 122 receives from the portable terminal 110 traffic information related to an unexpected vehicle accident that occurs in any one section in the city. The traffic information includes positional information grasped through the GPS receiving unit 111 and images obtained through the imaging unit 112. Based on the received traffic information, the traffic information managing unit 122 sets, as a congestion section, a region near where the vehicle accident occurs.

Also, the traffic information managing unit 122 updates a travel path based on updated traffic information. The updated travel path may bypass the place where the vehicle accident occurs. The updated travel path information is delivered to the interface unit 121. The database unit 123 stores various pieces of traffic information and map information that are required for a road guide service. Based on the information stored in the database unit 123, the traffic information managing unit 122 updates real-time traffic information delivered from the portable device 110. The updated traffic information is stored in the database unit 123.

The condition control unit 124 controls the operations between components of the server 120. For example, the condition control unit 124 allows the information delivered to the interface unit 121 through the wireless communication unit 115 to be delivered to the traffic information managing unit 122. Also, the condition control unit 124 allows information on a new travel path generated from the traffic information managing unit 122 to be fed back to the portable device 110.

As described above, the server 120 continuously receives real-time traffic information from the portable device 110. The server 120 generates a new travel path so that a user may bypass an unexpected congestion sections to reach a destination. Also, the server 120 may receive traffic condition and travel path information from each of a plurality of portable devices 110 and deliver updated travel path information to each of the portable devices 110. Thus, a user may reach the destination with the shortest time by continuously using new traffic information.

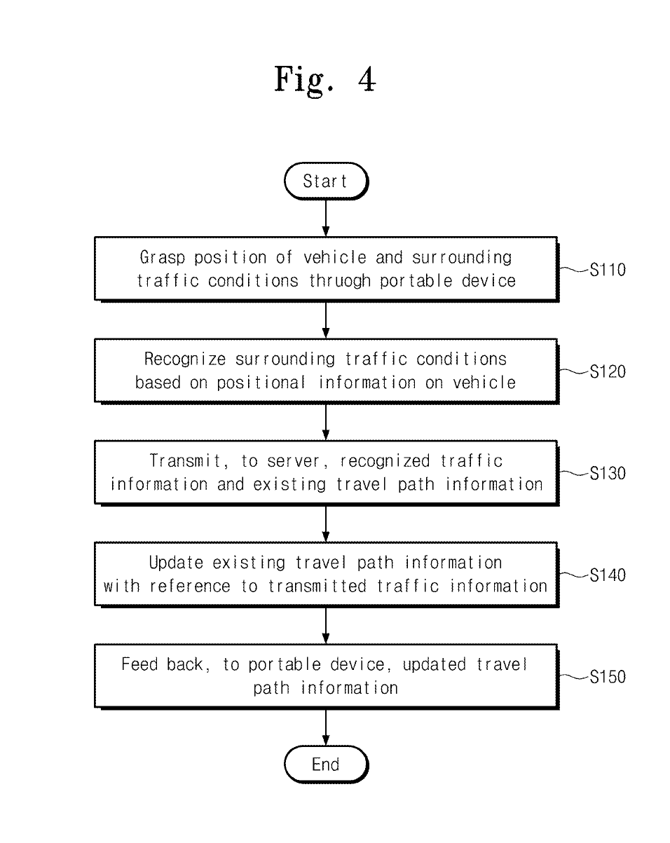

FIG. 4 is a flow chart of how a road guide system according to an embodiment of the present invention operates. Referring to FIG. 4, in step S110, the position of a vehicle is grasped and surrounding traffic conditions are imaged, through the portable device 110 (See FIG. 2). The portable device 110 grasps the position of the vehicle by using GPS. Also, the portable device 110 images unexpected vehicle accidents and road damages by using an imaging device, such as a camera. The road guide system 100 according to the present invention grasps surrounding traffic conditions directly through the portable device 110 and updates traffic information in real time.

In step S120, surrounding traffic conditions are recognized based on the position information on the vehicle. By grasping the positional information on the vehicle through the GPS, it is possible to grasp where accidents occur. The accidents may include vehicle accidents, road construction, and road damages.

In step S130, the traffic information and the travel path information that are recognized in step S120 are transmitted to the server 120. The condition control unit 124 (See FIG. 3) allows the traffic information and the travel path information to be delivered to the traffic information managing unit 122 (See FIG. 3).

In step S140, the travel path information is updated with reference to real-time traffic information. The control unit 124 allows the traffic information control unit 122 to update the travel path information. Based on collected traffic information and existing travel path information, the traffic information managing unit 122 generates new travel path information by which a user may reach a destination within the shortest time.

In step S150, travel path information updated from the traffic information managing unit 122 is fed back to the portable device. The condition control unit 124 allows the updated travel path information to be fed back to the portable device 110. Thus, the user may reach the destination according to the received updated travel path information.

As described above, the road guide system 100 according to the present invention directly images the surrounding traffic conditions of a vehicle through the portable device 110. Also, the road guide system 100 provides, to a user, new travel path in real time through the interaction between the portable device 110 and the server 120. Thus, the user may use a faster and more exact road guide service than an existing road guide service.

According to the embodiments of the present invention, a real-time travel path service based on traffic conditions is provided through the interaction between the portable device and the server. Thus, a user may use a real-time updated travel path service.

Hitherto, the best mode was disclosed in the drawings and specification. While specific terms were used, they were not used to limit the meaning or the scope of the present invention described in Claims, but merely used to explain the present invention. Accordingly, a person having ordinary skill in the art will understand from the above that various modifications and other equivalent embodiments are also possible. Hence, the real protective scope of the present invention shall be determined by the technical scope of the accompanying Claims.

What is claimed is:

1. An operating method of a road guide system, the operating method comprising:
collecting traffic information around a portable device through the portable device;
delivering, to a server, the traffic information collected from the portable device and travel path information;
updating the delivered travel path information based on the delivered traffic information; and
feeding back the updated travel path information from the server to the portable device.

2. The operating method of claim 1, wherein the collecting of the traffic information comprises:
sensing positional information on the portable device through a global positioning system (GPS); and
imaging, through an imaging device, traffic conditions around the portable device.

3. The operating method of claim 1, further comprising storing the delivered traffic information in the server.

4. The operating method of claim 1, wherein the updating of the travel path information comprises updating the travel path information based on traffic information received from two or more portable devices.

5. The operating method of claim 1, wherein the server comprises map information that is required for updating the travel path information.

6. A road guide method of a portable device, the road guide method comprising:
searching for travel path information based on map information;
determining traffic conditions according to image information obtained by an imaging device;
transmitting the determined traffic situations and positional information to the server;
receiving, from the server, travel path information updated according to the traffic conditions; and
performing a road guide based on the updated travel path information.

7. The road guide method of claim 6, wherein the determining, the receiving, and performing of the road guide are repetitively carried out.
